(19) United States
(12) Patent Application Publication
(10) Pub. No.: US 2016/0027026 A1
(43) Pub. Date: Jan. 28, 2016

(54) ORDER QUANTITY DETERMINATION METHOD, COMPUTER-READABLE MEDIUM, AND INFORMATION PROCESSING DEVICE

(71) Applicant: FUJITSU LIMITED, Kawasaki-shi (JP)

(72) Inventors: Yoshinobu Matsui, Kawasaki (JP); YUHEI UMEDA, Kawasaki (JP); Kazuhiro Matsumoto, Kawasaki (JP); Hirokazu Anai, Hachioji (JP); Isamu Watanabe, Kawasaki (JP)

(73) Assignee: Fujitsu Limited, Kawasaki (JP)

(21) Appl. No.: 14/743,125

(22) Filed: Jun. 18, 2015

(30) Foreign Application Priority Data
Jul. 23, 2014 (JP) 2014-150225

(51) Int. Cl. G06Q 30/02; G06Q 10/08

(52) U.S. Cl. CPC G06Q 30/0202; G06Q 10/087

(57) ABSTRACT

An order quantity determination method includes: accepting lead time from product order to arrival; calculating a stock quantity of the product by a processor based on an arrival quantity of the product and a demand forecast value of the product, the arrival quantity of the product is calculated based on the accepted lead time and order time of the product; and calculating an order quantity of the product by a processor based on a cost for holding the calculated stock quantity of the product, a price of the product, and the demand forecast value of the product.

### CROSS-REFERENCE TO RELATED APPLICATION

This application is based upon and claims the benefit of priority of the prior Japanese Patent Application No. 2014-150225, filed on Jul. 23, 2014, the entire contents of which are incorporated herein by reference.

### FIELD

The embodiments discussed herein are related to an order quantity determination method, a computer-readable medium, and an information processing device.

### BACKGROUND

There is a technique that forecasts a demand quantity of a product to manage a stock quantity in a warehouse by determining a safe order quantity to the extent not causing stock shortage from a difference from its forecast error. The forecast error is a number of product items sold more than a demand forecast of the product. In such technique, an order quantity of the product is determined by adding the forecast error to the forecasted demand quantity of the product. In such a manner, by ordering more product items than the forecasted demand quantity, losing the sales opportunity of the product due to running out of the stock is avoided when the actual demand grows more than the forecasted demand.

As a related art document, there is Japanese Laid-open Patent Publication No. 2007-200185.

Products take some period from order to arrival. The period from order to arrival of a product is called as lead time. For example, when lead time is long, a product sometimes does not arrive in demanded timing, causing loss of the sales opportunity and a decrease in the profit. In addition, when lead time is long, the cost for holding the product sometimes increases and the profit sometimes decreases due to an excessive stock in a warehouse by ordering the product in accordance with the demand although there is an ordered and not yet arrived product.

### SUMMARY

According to an aspect of the invention, an order quantity determination method includes: accepting lead time from product order to arrival; calculating a stock quantity of the product by a processor based on an arrival quantity of the product and a demand forecast value of the product, the arrival quantity of the product is calculated based on the accepted lead time and order time of the product; and calculating an order quantity of the product by a processor based on a cost for holding the calculated stock quantity of the product, a price of the product, and the demand forecast value of the product.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration example of an information processing device according to a first embodiment;

FIG. 2 illustrates an example of a data structure of sales data;

FIG. 3 illustrates an example of a data structure of a setting information table;

FIG. 4 illustrates an example of a data structure of a forecasted demand quantity table;

FIG. 5 illustrates an example of an order quantity determination system;

FIG. 6 is an illustration of lead time from order of a product to delivery to a warehouse;

FIG. 7 illustrates a first example of a GUI image;

FIG. 8 is a flow chart illustrating an example of a flow of entire process to obtain an optimized order quantity;

FIG. 9 illustrates a first example of a forecasted demand quantity;

FIG. 10 illustrates a first example of an optimized order quantity;

FIG. 11 illustrates a first example of a forecasted profit;

FIG. 12 illustrates a second example of the forecasted demand quantity;

FIG. 13 illustrates a second example of the optimized order quantity;

FIG. 14 illustrates a second example of the forecasted profit;

FIG. 15 is a functional block diagram illustrating a configuration example of an information processing device according to a second embodiment;

FIG. 16 illustrates a second example of the GUI image; and

FIG. 17 illustrates a hardware configuration of the information processing device of the first embodiment or the second embodiment.

### DESCRIPTION OF EMBODIMENTS

According to a mode of an embodiment of an order quantity determination method disclosed herein, it is possible to determine an order quantity considering the profit. Detailed descriptions are given below to embodiments of an order quantity determination method, an order quantity determination program, and an information processing device that are disclosed herein based on the drawings. It is to be noted that the scope of the present claims is not limited by the embodiments. It is possible to appropriately combine each embodiment without contradicting the process contents.

### First Embodiment

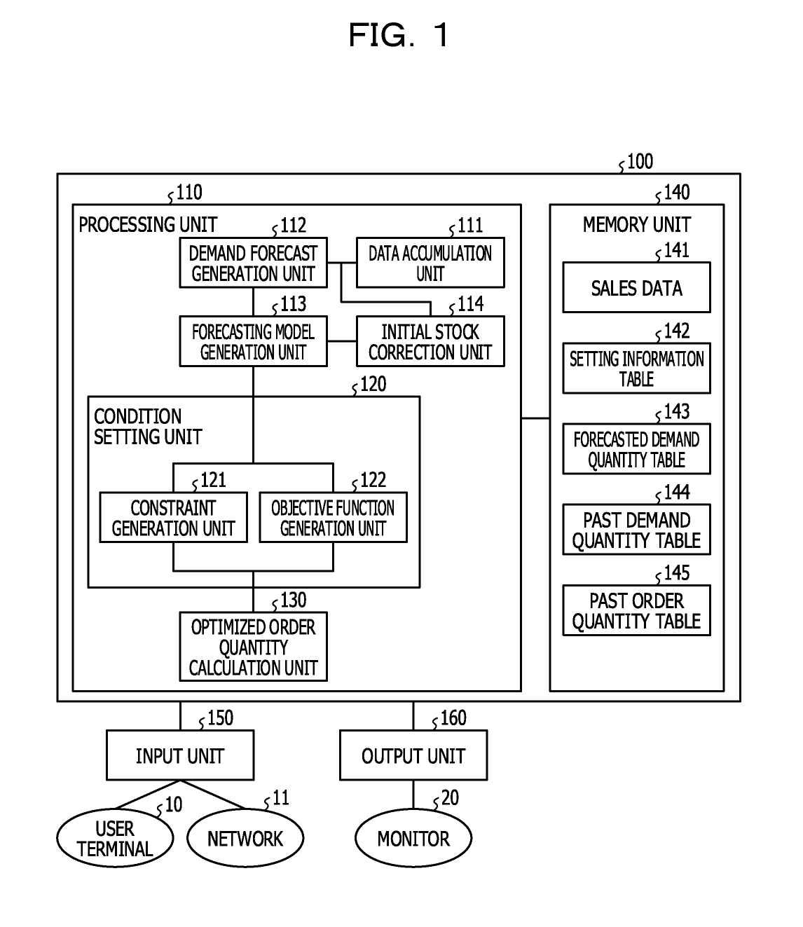

An example of the entire configuration of an information processing device 100 according to a first embodiment is described. FIG. 1 is a functional block diagram illustrating a configuration of an information processing device according to the first embodiment. The information processing device 100 is a device that determines an order quantity of a product. The information processing device 100 is, for example, a computer such as a personal computer and a server computer. The information processing device 100 may be implemented as one computer and may also be implemented by a plurality of computers. In the present embodiment, descriptions are given using an example where the information processing device 100 is one computer. As illustrated in the example of FIG. 1, the information processing device 100 has a processing unit 110 and a memory unit 140.

(Description on Memory Unit)

The memory unit 140 has sales data 141, a setting information table 142, a forecasted demand quantity table 143, a past demand quantity table 144, and a past order quantity table 145. The memory unit 140 corresponds to, for example, a semiconductor memory device, such as a random access memory (RAM), a read only memory (ROM), and a flash memory, or a storage device, such as a hard disk and an optical disk.

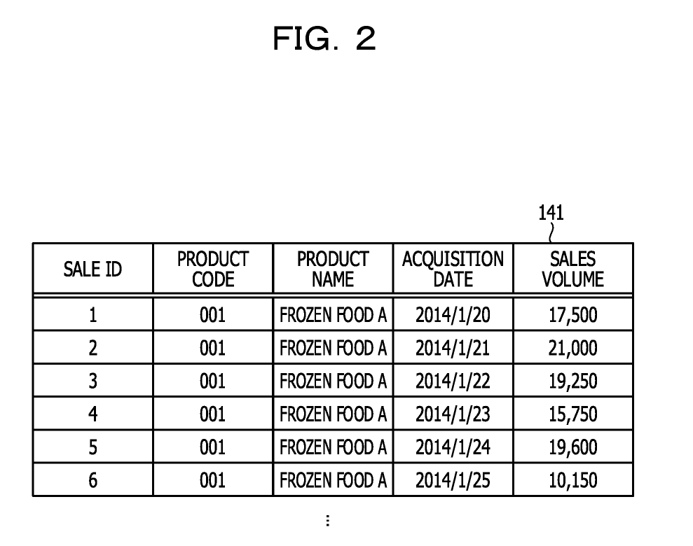

FIG. 2 is a chart illustrating an example of a data structure of sales data. The sales data 141 retains sales information of each product for each period. For example, the sales data 141 is inputted from an external point of sale (POS) system. As illustrated in the example of FIG. 2, the sales data 141 associates a sale ID, a product code, a product name, an acquisition date, and a sales volume with each other. The “sale ID” is an identification number to identify a sales volume of a product for each period. The “product code” is a code assigned to each product uniquely. The “product name” is a name of the product corresponding to the product code. The “acquisition date” is a date when the sales information is acquired. In the first embodiment, each day is a period. The “sales volume” is a total value of sold product prices. Although the present embodiment uses an example of the case of memorizing product sales in the sales data 141 by day, the product sales may also be memorized by a predetermined accumulation period. For example, when the accumulation period is one hour each, sales data obtained by accumulating product sales for the one hour per hour during business hours on each business day is memorized in the sales data 141. As illustrated in the example of FIG. 2, the sales data 141 associates a sales volume on each day, using each day as a period, with a sale ID, a product code, a product name, and an acquisition date.

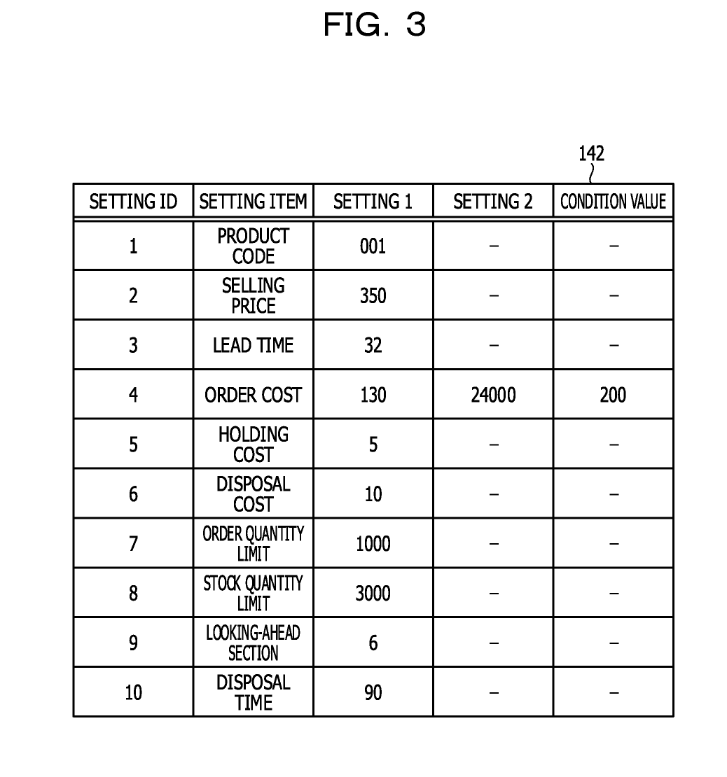

FIG. 3 is a chart illustrating an example of data structure of a setting information table. The setting information table 142 retains various types of setting information inputted from a user terminal 10. As illustrated in the example of FIG. 3, the setting information table 142 associates a setting ID, a setting item, setting 1, setting 2, and a condition value with each other. The “setting ID” is an identification number assigned to each setting information item uniquely. The “setting item” is an item name set to a product. The “setting 1” is a first setting value for each item. The “setting 2” is a second setting value for each item. The “condition value” is a value to be a condition to switch between setting 1 and setting 2. When the “setting item” has only one setting value, a setting value is inputted only in the setting 1 and “-” is stored in the “setting 2” and the “condition value”.

Next, using FIG. 3, each setting item of the setting information table 142 is described. The product code of a setting ID “1” is a code uniquely assigned to each product and corresponds to the product code of the sales data 141. The selling price of a setting ID “2” is a price for selling a product. For example, as illustrated in the example of FIG. 3, the setting information table 142 indicates that the selling price for one product item is 350 yen. The lead time of a setting ID “3” is time from order of a product to a manufacturer to arrival of the product in a warehouse. The lead time varies depending on the type of product, the order destination, and the like. For example, as illustrated in the example of FIG. 3, the setting information table 142 indicates that the lead time is 32 hours. Although the present embodiment uses an example of the case where the unit of the lead time is hour, the unit of the lead time may also be a unit of a predetermined cycle such as a day, a week, and a period, which is an order cycle. The value of the lead time is not limited to an integer and may also include a decimal fraction. For example, when the unit of the lead time is a day and the value of the lead time is “2.5”, it indicates that the product arrives after 2.5 days from the order. In addition when, for example, the unit of the lead time is an order cycle, the order cycle is three days, and the value of the lead time is “2”, it indicates that the product arrives after six days, which is two order cycles after the order.

An order cost of a setting ID “4” is a cost for ordering one product item. The order cost also includes charges for shipping, handling, and the like as well as a purchase price for one product item. The order cost for one product is sometimes less in a case of purchasing in a set unit than a case of purchasing for one product item. In this case, the setting information table 142 may have an order cost for one product item in the setting 1 of the setting ID “4”, may have an order cost for one set in the setting 2, and may have the number of items included in one set in the condition value. For example, as illustrated in the example of FIG. 3, the setting information table 142 indicates that the order cost for one product item is 130 yen and the order cost for one set is 24000 yen. The setting information table 142 also indicates that the number of product items included for one set is 200 items.

A holding cost of a setting ID “5” is a cost used for holding one product item for one period. The holding cost increases in proportion to the period of holding the product. For example, as illustrated in the example of FIG. 3, the setting information table 142 indicates that the holding cost for holding one product item for one period is 5 yen. A disposal cost of a setting ID “6” is a cost occurring when one product item is disposed. For example, as illustrated in the example of FIG. 3, the setting information table 142 indicates that the disposal cost for one product item is 10 yen. An order quantity limit of a setting ID “7” is a maximum number of product items that may be ordered to a manufacturer at one time. For example, as illustrated in the example of FIG. 3, the setting information table 142 indicates that the order quantity limit is 1000 product items per order. A stock quantity limit of a setting ID “8” is a maximum number of product items that may be stored in a warehouse. For example, as illustrated in the example of FIG. 3, the setting information table 142 indicates that the stock quantity limit is 3000 product items. A looking-ahead section of a setting ID “9” is a forecast period to forecast a demand quantity of the product. For example, as illustrated in the example of FIG. 3, the setting information table 142 indicates that the looking-ahead section is six periods. Disposal time of a setting ID “10” is time from order to disposal of a product. For example, as illustrated in the example of FIG. 3, the setting information table 142 indicates that a product is disposed after 90 hours from order. Although the present embodiment uses an example of the case where the unit of the disposal time is an hour, the unit of the disposal time may also be a unit of a predetermined cycle such as a day, a week, and a period, which is an order cycle. The value of the disposal time is not limited to an integer and may also include a decimal fraction.

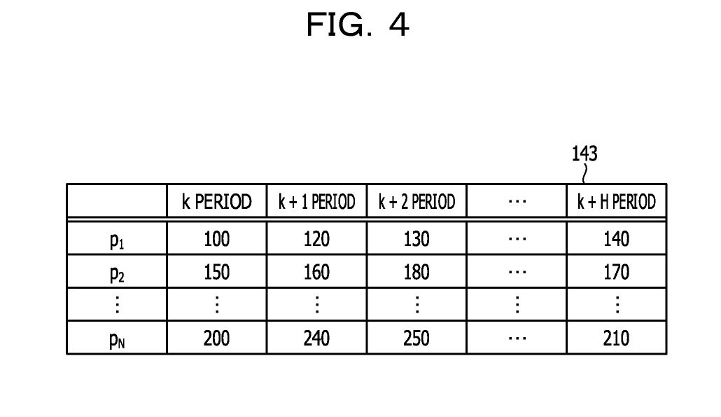

FIG. 4 is a chart illustrating an example of a data structure of a forecasted demand quantity table. The forecasted demand quantity table 143 is a table that associates a forecasted demand quantity with each forecasting method. The example of FIG. 4 represents an example of a result of forecasting a demand for one product. For example, the forecasted demand quantity table 143 is created by a demand forecast generation unit 112 described later. The demand forecast generation unit 112 described later forecasts a product demand in a period H obtained by adding the period of the lead time to the looking-ahead section. For example, when the looking-ahead section is six periods and the period of the lead time is three periods, the period H to forecast a product demand becomes nine periods. When the lead time includes a decimal fraction, the period of the lead time is a period of a value obtained by rounding up a decimal fraction of the lead time. As illustrated in the example of FIG. 4, the forecasted demand quantity table 143 retains forecasted demand quantities in a k period through a k+H period forecasted respectively by N sorts of methods of forecasting a demand quantity p₁ through p_{N}. For example, the forecasted demand quantity table 143 indicates that the demand quantity in the k period of the forecasting method p₁ is 100, the demand quantity in the k+1 period is 120, the demand quantity in the k+2 period is 130, and the demand quantity in the k+H period is 140.

The past demand quantity table 144 retains data related to a demand quantity in the past from one period to a k−1 period. The past demand quantity table 144 may also appropriately retain an actual demand quantity accumulated by a data accumulation unit 111.

The past order quantity table 145 retains data related to an already ordered order quantity of the product. For example, the past order quantity table 145 retains an order quantity of the product outputted from an output unit 160 described later.

(Description on Input Unit)

Back to FIG. 1, the information processing device 100 is connected to an input unit 150 and the output unit 160. The input unit 150 is a processing unit accepting an input of, for example, sales information from an external POS system and setting information from the user terminal 10. The input unit 150 accepts an input of setting information, such as the selling price of the product, the lead time, the order cost, the holding cost, the disposal cost, the order quantity limit, the stock quantity limit, the looking-ahead section, and the disposal time, from the user terminal 10. The input unit 150 outputs each item of the accepted data to the setting information table 142.

The input unit 150 also accepts sales information from an external POS system via a network 11. The input unit 150 outputs the accepted sales information to the sales data 141 of the memory unit 140.

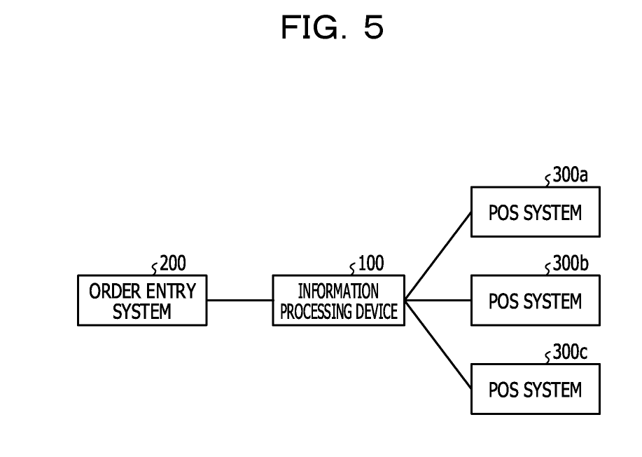

Using FIG. 5, communication between the information processing device 100 and another system is described. FIG. 5 is a diagram illustrating an example of an order quantity determination system. As illustrated in the example of FIG. 5, the information processing device 100 is communicatively connected to an order entry system 200, a POS system 300a, a POS system 300b, and a POS system 300c. The POS systems 300a, 300b, and 300c send sales data for each period to the information processing device 100. The information processing device 100 calculates an optimized order quantity of the product based on the received sales data. The information processing device 100 appropriately sends product order information to the order entry system 200 by a user instruction. After receiving the order information, the order entry system 200 sends order entry confirmation to the information processing device 100.

(Description on Processing Unit)

Back to FIG. 1, the processing unit 110 has the data accumulation unit 111, the demand forecast generation unit 112, a forecasting model generation unit 113, an initial stock correction unit 114, a condition setting unit 120, and an optimized order quantity calculation unit 130. The condition setting unit 120 has a constraint generation unit 121 and an objective function generation unit 122.

It is possible to achieve each configuration of the processing unit 110 by causing, for example, a central processing unit (CPU) to execute a predetermined program. It is possible to achieve the function of the processing unit 110 by an integrated circuit, such as an application specific integrated circuit (ASIC) and a field programmable gate array (FPGA), for example.

The processing unit 110 accepts constraint information to calculate a profit based on the order quantity of the product via the input unit 150. For example, the processing unit 110 accepts an input of the setting information, such as the selling price of the product, the lead time, the order cost, the holding cost, the disposal cost, the order quantity limit, the stock quantity limit, the looking-ahead section, and the disposal time, as the constraint information via the input unit 150. The processing unit 110 searches for an order quantity for a greater profit using the constraint information. For example, the processing unit 110 obtains an order quantity for the k period by solving an optimization problem using a profit from the k period to the k+H period as the objective function considering any one or a plurality of constraint information items. For example, the demand forecast generation unit 112 forecasts a demand from the k period to the k+H period. For example, the demand forecast generation unit 112 forecasts the demand from the k period to the k+H period using a plurality of approaches for each approach. The period H is a period greater than or equal to the period obtained by adding the period of the lead time to the looking-ahead section. The optimized order quantity calculation unit 130 obtains the order quantity for the k period by solving an optimization problem using the profit from the k period to the k+H period as the objective function considering the forecasted demand. For example, the optimized order quantity calculation unit 130 obtains the order quantity for the k period by solving an optimization problem using the profit from the k period to the k+H period as the objective function for a higher profit that may be minimally secured. In such a manner, the optimized order quantity calculation unit 130 forecasts a demand in the period greater than or equal to the period obtained by adding the period of the lead time to the looking-ahead section, thereby forecasting a change in stock figure when the product ordered in the looking-ahead section is delivered in the period of the lead time. This enables the optimized order quantity calculation unit 130 to forecast how many to order in the looking-ahead section inclusive of the change in stock figure in the period of the lead time, so that it is possible to improve precision of the order to obtain an order figure for a higher profit. The output unit 160 outputs a profit forecast together with the obtained order quantity. The input unit 150 is an example of an acceptance unit. The demand forecast generation unit 112 is an example of a first calculation unit. The optimized order quantity calculation unit 130 is an example of a second calculation unit. Detailed descriptions are given below to each configuration of the processing unit 110.

The data accumulation unit 111 is a processing unit to accumulate actual sales data from an external POS system. The data accumulation unit 111 accumulates sales information acquired from the sales data 141 to obtain an actual product demand quantity Dᵣ[k−1]. Dᵣ[k−1] is a number of product items sold in a k−1 period one period prior to the current k period. The data accumulation unit 111 outputs the actual product demand quantity Dᵣ[k−1] to the memory unit 140. In such a manner, the data accumulation unit 111 outputs the actual product demand quantity Dᵣ to the past demand quantity table 144 every time a period passes. The past demand quantity table 144 retains product demand quantities in the past Dᵣ[1] through Dᵣ[k−1] from one period to a k−1 period.

The demand forecast generation unit 112 is a processing unit to forecast a demand quantity by calculating the stock quantity of the product based on the arrival quantity of the product calculated based on the lead time and the demand forecast value of the product. The demand forecast generation unit 112 forecasts a demand quantity from the k period to the k+H period, ahead of the period H, obtained by adding the looking-ahead section to the period of the lead time. For example, the demand forecast generation unit 112 calculates forecasted demand quantities Dₚᵢ[k] through Dₚᵢ[k+H] (i=1, . . . , N) from the k period to the k+H period respectively by the N sorts of methods of forecasting a demand quantity p₁ through p_{N} using the demand quantities Dᵣ[1] through Dᵣ[k−1] included in the past demand quantity table 144. Then, the demand forecast generation unit 112 outputs the respective forecasted demand quantities Dₚᵢ[k] through Dₚᵢ[k+H] to the forecasted demand quantity table 143.

Here, an example of methods of forecasting a demand quantity to be used as the forecasting methods p₁ through p_{N} is described. For example, when demand quantities of the product for past several years are memorized in the past demand quantity table 144, an average of the demand quantities in a period in the past corresponding to the k period is forecasted as the forecasted demand quantities Dₚᵢ[k]. Among the past several years, the demand quantities in a period close to the present may also be weighted more. The period in the past corresponding to the k period may also be, for example, a same date. The period in the past corresponding to the k period may also be, for example, a date corresponding to a same day of the same week in the same month in the past as a day of the week in the month of the current date obtained regarding the k period. The past demand quantity table 144 may also memorize information, such as weather and events, and corrects the demand quantities in the past using the information to make the forecasted demand quantities. For example, an index value indicating whether the weather and the event are suitable for the product demand is memorized. Then, the forecasted demand quantities may also be calculated by correcting the demand quantities in the past with the index value. For example, when the index value is set to be close to 1 as being more suitable for the demand and close to 0 as being less suitable for the demand, the demand forecast generation unit 112 obtains standard demand quantities by dividing the demand in the past by the index value and calculates forecasted demand quantities by multiplying the standard demand quantities by the index value forecasted for the k period. The methods of forecasting a demand quantity are not limited to them and it is possible to use various types of other forecasting methods. For example, the demand quantities may also be forecasted by learning the demand in the past with a support vector machine and the like. In addition, the methods of forecasting a demand quantity p₁ through p_{N} include those estimating the demand quantities more and those estimating the demand quantities less compared with other forecasting methods. The methods of forecasting a demand quantity estimating the demand quantities more may include, for example, a method in which the largest demand quantity is made to be the forecasted demand quantity among the demand quantities of the product in past several years in the period corresponding to the k period and a method in which a predetermined safety factor is multiplied by an average of the demand quantities of the product for past several years. The methods of forecasting a demand quantity estimating the demand quantities less may include, for example, a method in which the smallest demand quantity is made to be the forecasted demand quantity among the demand quantities of the product for past several years in the period corresponding to the k period and a method in which a predetermined ratio is reduced from an average of the demand quantities of the product for past several years. This enables the demand forecast generation unit 112 to provide ranges in the forecasted demand quantities Dₚ by calculating the plurality of forecasted demand quantities Dₚ using the plurality of forecasting methods.

The forecasting model generation unit 113 is a processing unit that generates a basic model to calculate a stock figure for each period.

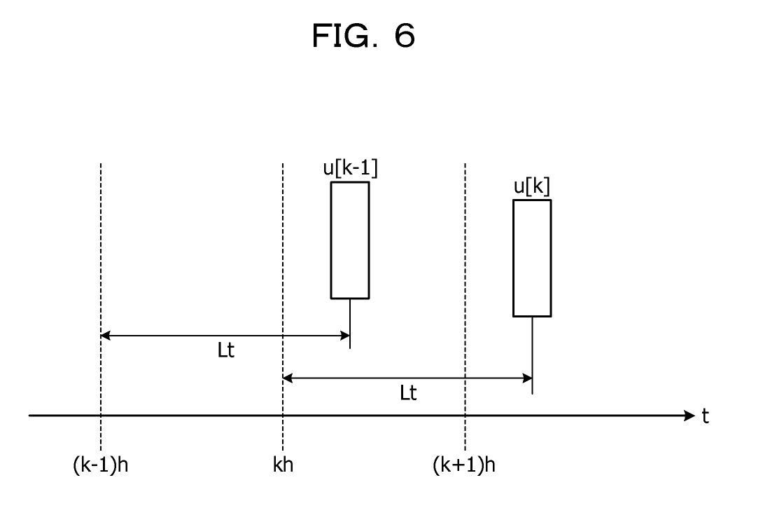

Here, generally, products take some period from order to arrival. FIG. 6 is an illustration of lead time from order of a product to delivery to a warehouse. As illustrated in the example of FIG. 6, a product arrives at a warehouse after lead time Lt passes from order of the product. For example, an order placement u[k−1] is a product ordered in the k−1 period. The product ordered in the k−1 period arrives at a warehouse after passing the k period. An order placement u[k] is a product ordered in the k period. The product ordered in the k period arrives at a warehouse after passing the k+1 period. In such a manner, depending on the order destination and the type of product, a product ordered in a previous period sometimes arrives after passing the next period.

The forecasting model generation unit 113 then forecasts the stock quantity of the product taking a product amount to arrive based on the lead time from order of the product to delivery to a warehouse into account. For example, the forecasting model generation unit 113 acquires the lead time from the setting information table 142. Then, the forecasting model generation unit 113 forecasts the stock quantity of the product for the addition period in which the period of the lead time is added to the looking-ahead section, which is a predetermined forecast period.

For example, when the unit of the lead time is a period, which is an order cycle, and the value of the lead time is an integer, the forecasting model generation unit 113 forecasts the stock quantity of the product by carrying out, to the actual stock quantity, addition of the number of product items to arrive and subtraction of the demand quantity of the product. Specifically, the forecasting model generation unit 113 generates a basic model M₁ expressed in the following formulae (1) and (2). A forecasted stock figure in a warehouse at the beginning of the k+1 period is yₚ[k+1], a stock figure actually existing in the warehouse at the beginning of the k period is yᵣ[k], and the lead time is Lt. An order quantity in the k−Lt period, which is before the lead time Lt from the k period, is u[k−Lt], the forecasted demand quantity in the k period is Dₚ[k], and a maximum stock figure held in the k period is St.

M₁: yₚ[k+1]=yᵣ[k]+u[k−Lt]−Dₚ[k] (1)

St=y[k]+u[k−Lt] (2)

When the lead time Lt is considered, u[k−Lt] ordered in the k−Lt period is delivered in the k period. Thus, in the formulae (1) and (2) of the forecasting model of the forecasted stock figure yₚ[k+1] in the k+1 period, u[k−Lt] is added to the stock figure yᵣ[k] in the k period.

For example, when the unit of the lead time is a period, which is an order cycle, and the value of the lead time includes a decimal fraction, the initial stock correction unit 114 forecasts the demand quantity of the product in a period corresponding to a decimal part of the lead time.

Here, an example of the forecasting method to forecast the demand quantity of the product in a period corresponding to a decimal part of the lead time is described. For example, when the demand quantities of the product for past several years are memorized in the past demand quantity table 144, the initial stock correction unit 114 obtains an average of the demand quantities in a period in the past corresponding to the k period. Then, the initial stock correction unit 114 forecasts the demand quantity of the product in a period corresponding to a decimal part of the lead time by multiplying the average of the demand quantities in the period in the past corresponding to the k period by a value of a decimal fraction part of the lead time. The method of forecasting a demand quantity corresponding to the decimal part of the lead time is not limited to this and it is possible to use various other forecasting methods. For example, the initial stock correction unit 114 may also forecast the demand quantity by learning the demand in the past with a support vector machine and the like. For example, when the accumulation period of the demand quantity of the product is shorter than a period, the initial stock correction unit 114 may also forecast the demand quantity corresponding to the decimal part of the lead time by obtaining the demand quantity for each accumulation period included in the period and adding the demand quantity in the accumulation period corresponding to the period of the decimal fraction. For example, it is assumed that the decimal part of the lead time is 0.5, the period is one day, and the accumulation period is one hour. In this case, the initial stock correction unit 114 may also forecast the demand quantity by obtaining the demand quantity of the product per hour during business hours and adding the demand quantity of the product for the time corresponding to 0.5 of the decimal part of the lead time. When order time is fixed, the initial stock correction unit 114 may also forecast the demand quantity by adding the demand quantity of the product for the time corresponding to the decimal part of the lead time from the order time. For example, when the decimal part of the lead time is 0.5, the order time is 18 o'clock, and the business hours are 16 hours from 8 o'clock to 24 o'clock, the time corresponding to 0.5 of the decimal part of the lead time is eight hours. In this case, the initial stock correction unit 114 forecasts the demand quantity by adding the demand quantities of the product from the order time at 18 o'clock to 24 o'clock and from 8 o'clock to 10 o'clock. The forecasted demand quantities corresponding to the decimal part of the lead time may be mDₚ[k].

When the unit of the lead time is a period, which is an order cycle, and the value of the lead time includes a decimal fraction, the forecasting model generation unit 113 corrects the stock figure actually existing in the warehouse to the stock figure in delivery timing. For example, the forecasting model generation unit 113 corrects the stock figure yᵣ[k] actually existing in the warehouse at the beginning of the k period using the demand quantities mDₚ[k] of the decimal part of the lead time forecasted by the initial stock correction unit 114.

Here, when the forecasted demand quantities mDₚ[k] is subtracted from a product stock figure, the stock figure may be a negative value in a case that the forecasted demand quantity mDₚ[k] is more than the stock figure. However, since there is no product to sell when the product stock figure becomes zero, the product stock figure does not become less than zero.

The initial stock correction unit 114 then corrects the corrected stock figure in the k period as the following formula (3). The corrected stock figure in the k period is assumed to be yp(k).

yp(k)=max(yᵣ[k]−mDₚ[k],0) (3)

In the formula (3), when a result of subtracting the forecasted demand quantity mDₚ[k] corresponding to the decimal part of the lead time from the stock figure yᵣ[k] actually existing in the warehouse at the beginning of the k period is more than zero. The corrected stock figure yp(k) in the k period becomes yᵣ[k]−mDₚ. In the formula (3), when the result of subtracting the forecasted demand quantity mDₚ[k] corresponding to the decimal part of the lead time from the stock figure yᵣ[k] actually existing in the warehouse at the beginning of the k period is zero or less, the corrected stock figure yp(k) in the k period becomes zero.

The corrected stock figure yp(k) in the k period indicates a stock figure at the time of delivery when a product is delivered. The forecasting model generation unit 113 forecasts the stock quantity of the product by carrying out, to the stock quantity yp(k) after correction, addition of the number of product items to arrive and subtraction of the demand quantity of the product. Specifically, the forecasting model generation unit 113 generates a basic model M₂ expressed in the following formula (4).

M₂: yₚ[k+1]=yp(k)+u[k−Lt]−Dₚ[k] (4)

The maximum stock figure St is expressed by formula (5).

St=yp(k)+u[k−Lt] (5)

When the unit of the lead time is hour, the initial stock correction unit 114 may also forecast the demand quantity of the product using the lead time and an order interval. For example, the forecasting model generation unit 113 acquires the lead time from the setting information table 142. The forecasting model generation unit 113 generates a basic model M₃ in the following formula (6) based on the acquired lead time. In the formula (6), the lead time is Lt and the order interval is h.

M₃: yₚ[k+1]=yᵣ[k]+u[k−floor(Lt/h)]−Dₚ[k] (6)

When Lt/h includes a decimal part, similar to the basic model M₂, the stock figure yᵣ[k] in the k period may also be replaced with the corrected stock figure yp(k). The maximum stock figure St is expressed by the formula (2) when Lt/h does not include a decimal part and expressed by the formula (5) when Lt/h includes a decimal part.

The forecasting model generation unit 113 may also reflect the number of product items to be disposed after the disposal time passes from order of the product on the basic model. The forecasting model generation unit 113 acquires the disposal time from the setting information table 142. The forecasting model generation unit 113 generates a basic model M₄ in the following formula (7) based on the acquired disposal time. In the formula (7), the disposal time is Wt. The formula (7) is an example of a case that the unit of the lead time is hour. When the unit of the lead time is a period, which is an order cycle, similar to the basic model M₁, u[k−floor(Wt/h)] may be replaced with u[k−Lt] and y[k−floor(Wt/h)] may also be replaced with y[k−Lt]. When Wt/h includes a decimal part, similar to the basic model M₂, the stock figure yᵣ[k] in the k period may also be replaced with the corrected stock figure yp(k). The maximum stock figure St is expressed by the formula (2) when Wt/h does not include a decimal part and expressed by the formula (5) when Lt/h includes a decimal part.

$${M}_{4} \text{:} if u [ k - floor ( {W}_{t} / h ) ] - y [ k - floor ( {W}_{t} / h ) ] - {\sum }_{1 = k - floor ( {W}_{t} / h )}^{k} D [ 1 ] \geq 0 \\ y [ k + 1 ] = y [ k ] + u [ k ] - D [ k ] - ( u [ k - floor ( {W}_{t} / h ) ] - y [ k - floor ( {W}_{t} / h ) ] - {\sum }_{1 = k - floor ( {W}_{t} / h )}^{k} D [ 1 ] ) \\ else \\ y [ k + 1 ] = y [ k ] + u [ k ] - D [ k ] \qquad ( 7 )$$

A conditional expression in the formula (7) is described. When a product to be disposed is left in the warehouse in the k period, the optimized order quantity calculation unit 130 uses the expression in the upper part of the basic model M₄. In contrast, when there is no product to be disposed in the warehouse in the k period, the optimized order quantity calculation unit 130 uses the expression in the lower part of the basic model M₄. That is, the optimized order quantity calculation unit 130 decides the presence of a product item to be disposed for each period to determine the basic model. Details of the process in the optimized order quantity calculation unit 130 are described later.

The constraint generation unit 121 is a processing unit to generate a constraint condition related to the product order. The constraint generation unit 121 generates, for example, the order quantity limit and the stock quantity limit as the constraint conditions. The constraint generation unit 121 acquires each constraint condition from the setting information table 142.

The constraint generation unit 121 generates, for example, a constraint expression related to the order quantity limit in the following formula (8). In the formula (8), the order quantity limit is Uu.

u[k]≦Uu,u[k+1]≦Uu, . . . ,u[k+H]≦Uu (8)

The constraint generation unit 121 generates, for example, a constraint expression related to the stock quantity limit in the following formula (9). In the formula (9), the stock quantity limit is Us.

yₚ[k+1]+u[k+1]≦Us,yₚ[k+2]+u[k+2]≦Us, . . . , yₚ[k+H]+u[k+H]≦Us (9)

The constraint generation unit 121 generates a constraint condition to make the stock quantity to be 0 or greater in all cases as a condition of not causing stock shortage. The constraint generation unit 121 generates, for example, a constraint expression related to a condition of not causing stock shortage in the following formula (10).

yₚ[k+1]≧0,yₚ[k+2]≧0, . . . , yₚ[k+H]≧0 (10)

The objective function generation unit 122 is a processing unit to generate an objective function. The objective function is a function to calculate a profit obtained from the k period to the k+H period using the forecasted demand quantity Dₚ, the stock quantity y, the an order quantity u, and the like. The objective function generation unit 122 acquires the selling price of the product, the order cost, and the holding cost from the setting information table 142. Subsequently, the objective function generation unit 122 generates an objective function O₁ in the following formula (11). In the formula (11), the selling price of the product is m, the order cost for the product is b, and the holding cost for the product is c.

$${O}_{1} : P = {\sum }_{i = k}^{K + H} m \times {D}_{P} [ i ] - ( b \times u [ i ] + c \times y [ i + 1 ] ) \qquad ( 11 )$$

When the order cost varies depending on the order quantity of the product, the objective function generation unit 122 may define an order cost in accordance with the order quantity by classification using a conditional expression. For example, the order cost for one product is sometimes less in a case of purchasing in a set unit than a case of purchasing for one product item. The objective function generation unit 122 acquires an order cost for one set and an order cost for one product item from the setting information table 142. Then, the objective function generation unit 122 generates an objective function O₂ in the following formula (12). In the formula (12), where one set is R product items, the order cost for one set is b₁ and the order cost for one product item is b₂. The selling price of the product is m and the holding cost for the product is c.

$${O}_{2} : P = {\sum }_{i = k}^{K + H} m \times {D}_{P} [ i ] - \{ {b}_{1} \times floor ( u [ i ] / R ) + {b}_{2} \times ( u [ i ] - R \times floor ( u [ i ] / R ) ) + c \times y [ i + 1 ] \} \qquad ( 12 )$$

The objective function generation unit 122 may also reflect the disposal cost produced for product disposal on the objective function. The objective function generation unit 122 acquires the disposal cost and the disposal time from the setting information table 142. Then, the objective function generation unit 122 generates an objective function O₃ in the following formula (13). In the formula (13), the selling price of the product is m, the order cost for the product is b, the holding cost for the product is c, the disposal cost for the product is d, and the disposal time of the product is Wt.

$${O}_{3} : P = {\sum }_{i = k}^{K + H} m \times {D}_{P} [ i ] - ( b \times u [ i ] + c \times {y}_{P} [ i + 1 ] ) - d \times ( u [ i - floor ( {W}_{t} / h ) ] - y [ i - floor ( {W}_{t} / h ) ] - {\sum }_{1 = k - floor ( {W}_{t} / h )}^{k} D [ 1 ] ) \qquad ( 13 )$$

The optimized order quantity calculation unit 130 is a processing unit to calculate an optimized order quantity for a higher profit in a specified period within a range of satisfying the constraint condition. The optimized order quantity calculation unit 130 obtains optimized order quantities u[k] through u[k+H] in the specified period from the k period to the k+H period by solving an optimization problem using a plurality of demand forecasts based on the basic model, the constraint condition, and the objective function.

For example, the optimized order quantity calculation unit 130 solves an optimization problem to have a higher minimum value of the profit to obtain the optimized order quantity u[k+j] (j=1, . . . , H) in each period. For example, the optimized order quantity calculation unit 130 solves an optimization problem using formulae (14) and (15) below. The formula (14) is a mathematical expression to calculate an order quantity for the highest minimum value of the profit. In the formula (14), Pᵢ is a profit calculated by applying the forecasted demand quantities Dᵣ[k] through Dᵣ[k+H] acquired by the method of forecasting a demand quantity pᵢ (i=1, . . . , N) to the objective function. The formula (15) is a constraint expression generated by the constraint generation unit 121. The optimized order quantity calculation unit 130 sets the optimized order quantities u[k] through u[k+H] within a range of satisfying the conditional expression in the formula (15) to maximize the smallest minPᵢ among P₁ through P_{N}.

$$\begin{matrix}{max}_{u [ k ] , … , u [ k + H ]} {min}_{pi} {P}_{i} ( i = 1 , … , N ) & ( 14 ) \\ {y}_{pi} [ k + j ] \geq 0 , u [ k + j ] < Uu , {St}_{pi} [ k + j ] < Us ( j = 1 , … , H ) & ( 15 )\end{matrix}$$

Subsequently, the optimized order quantity calculation unit 130 calculates a profit range assumed based on the order quantity in each period that is set. For example, the optimized order quantity calculation unit 130 calculates forecast profits P₁ through P_{N} corresponding respectively to the forecasting methods p₁ through p_{N} using the order quantities u[k] through u[k+H] in the respective period that are set. Subsequently, the optimized order quantity calculation unit 130 acquires a maximum value and a minimum value of the forecast profits among the calculated forecast profits P₁ through P_{N} to obtain the profit forecast range. That is, the optimized order quantity calculation unit 130 makes the maximum value of the forecast profits to be the upper limit of the profit forecast range and the minimum value of the forecast profits to be the lower limit of the profit forecast range.

(Description on Output Unit)

The output unit 160 is a processing unit to output various types of information related to processing results. The output unit 160 outputs the order quantity to the order entry system 200. For example, the output unit 160 outputs the order quantity u[k] among the order quantities u[k] through u[k+H] for the highest minimum value of the profit to the order entry system 200. The order entry system 200 carries out a product order placement in the order quantity u[k]. The order entry system 200 may also be allowed to carry out a product order placement after display of the order quantity u[k] and correction of the order quantity by the user. The output unit 160 stores the order quantity u[k] outputted to the order entry system 200 in the past order quantity table 145. When the order entry system 200 is allowed to correct the order quantity, an actual order quantity may be received from the order entry system 200 and the actual order quantity may also be stored in the past order quantity table 145.

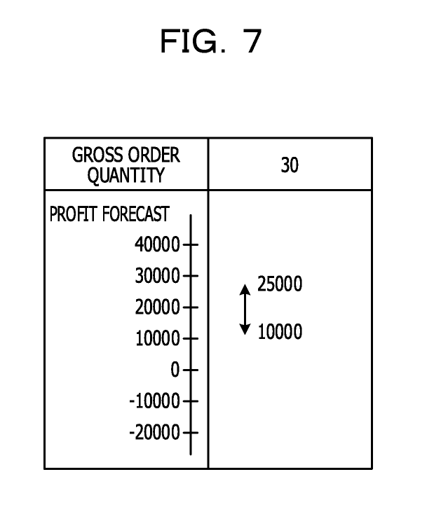

The output unit 160 outputs a GUI image representing a gross order quantity and a profit forecast range in a table format to an output device, such as a monitor. For example, the output unit 160 outputs a GUI image illustrated in FIG. 7 to a monitor 20. FIG. 7 is a diagram illustrating a first example of a GUI image. As illustrated in the example of FIG. 7, the output unit 160 outputs a GUI image illustrating that the maximum value of the profit forecast is 25000 and the minimum value is 10000 in terms of the gross order quantity of 30 to the monitor 20.

(Flow of Process)

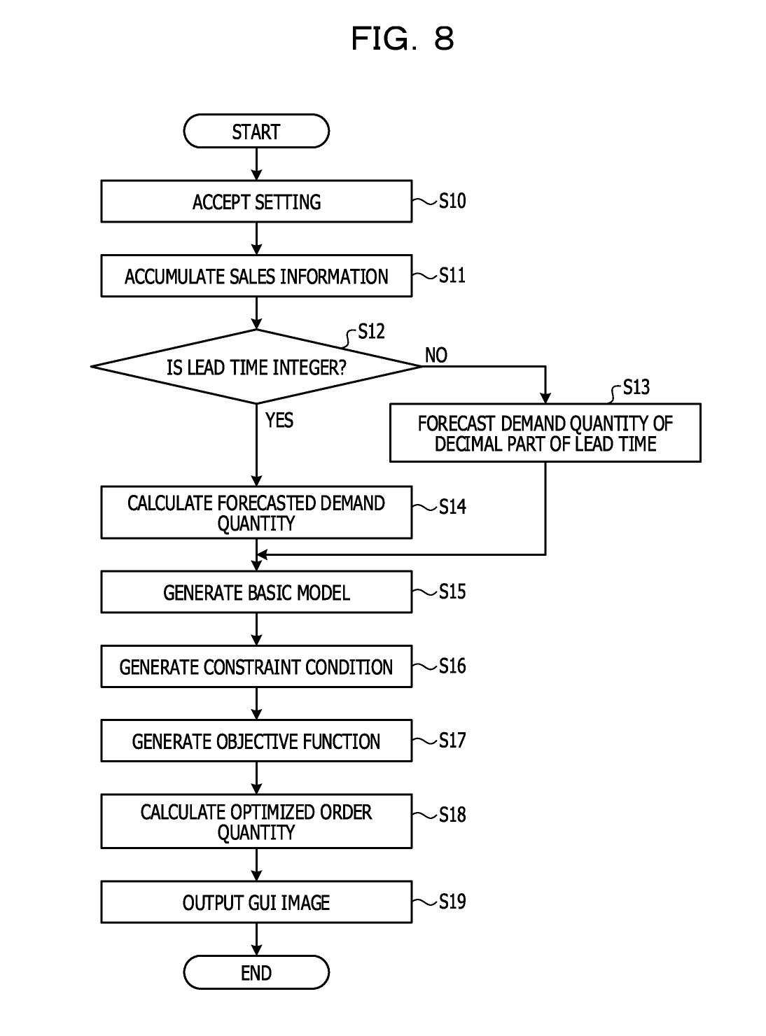

Next, using FIG. 8, process to obtain an optimized order quantity is described. FIG. 8 is a flow chart illustrating an example of a flow of the entire process to obtain an optimized order quantity. As illustrated in the example of FIG. 8, the input unit 150 accepts an input of various settings, such as the selling price of the product, the lead time, the order cost, the holding cost, the disposal cost, the order quantity limit, the stock quantity limit, the looking-ahead section, and the disposal time, from the user terminal 10 (step S10). The data accumulation unit 111 accumulates the sales information acquired from the sales data 141 for each period (step S11) and calculates the actual product demand quantity Dᵣ[k−1].

The initial stock correction unit 114 decides whether or not the lead time is an integer (step S12). When the lead time is an integer (yes in step S12), the process goes on to step S14 described later.

In contrast, when the lead time is other than an integer (no in step S12), the initial stock correction unit 114 forecasts the demand quantity of the product in a period corresponding to a decimal part of the lead time (step S13).

The demand forecast generation unit 112 calculates the forecasted demand quantities Dₚᵢ[k] through Dₚᵢ[k+H] (i=1, . . . , N) using the demand quantities Dᵣ[1] through Dᵣ[k−1] in the past by the N sorts of methods of forecasting a demand quantity p₁ through p_{N} (step S14).

The forecasting model generation unit 113 generates a basic model to calculate a stock figure for each period (step S15). The basic model includes an expression corresponding to the forecasted stock figure yₚ at the beginning of each period and an expression corresponding to the maximum stock quantity St forecasted in each period. When the lead time is other than an integer, the actual stock quantity of the product is corrected with the demand quantity corresponding to the decimal part of the lead time. The expression corresponding to the forecasted stock figure yₚ in the warehouse at the beginning of each period is, for example, the formula (1), (3), or (7). The expression corresponding to the maximum stock quantity St forecasted in each period is, for example, the formula (2) when the lead time is an integer and is the formula (5) when the lead time is other than an integer.

The constraint generation unit 121 generates a constraint condition corresponding to the order quantity limit and the stock quantity limit and a constraint condition to make the stock quantity to be 0 or greater in all cases as a condition of not causing stock shortage (step S16). The constraint condition corresponding to the order quantity limit is, for example, the formula (8). The constraint condition corresponding to the stock quantity limit is, for example, the formula (9). The constraint condition not causing stock shortage is, for example, the formula (10).

The objective function generation unit 122 generates an objective function to calculate the profit in the specified period k through k+H (step S17). The objective function is, for example, the formula (11), (12), or (13).

The optimized order quantity calculation unit 130 solves an optimization problem based on the basic model, the constraint condition, and the objective function to calculate the optimized order quantity for a higher profit in the specified period k through k+H (step S18). For example, the optimized order quantity calculation unit 130 obtains an optimized order quantity u[j] (j=k, . . . , k+H) in each period by solving an optimization problem using the formulae (14) and (15) for a higher profit that may be minimally secured. The optimized order quantity calculation unit 130 obtains the profit forecast range based on the optimized order quantities u[j] in each period.

The output unit 160 outputs a GUI image containing display of the gross order quantity and the profit forecast range to the monitor 20 (step S19). The displayed GUI image at this point is, for example, illustrated in FIG. 7.

This enables the information processing device 100 to obtain an order quantity for a higher profit to be secured while suppressing the holding cost for the product and the disposal cost for the product minimally and suppressing the stock shortage.

(Effect for Forecast Uncertainty)

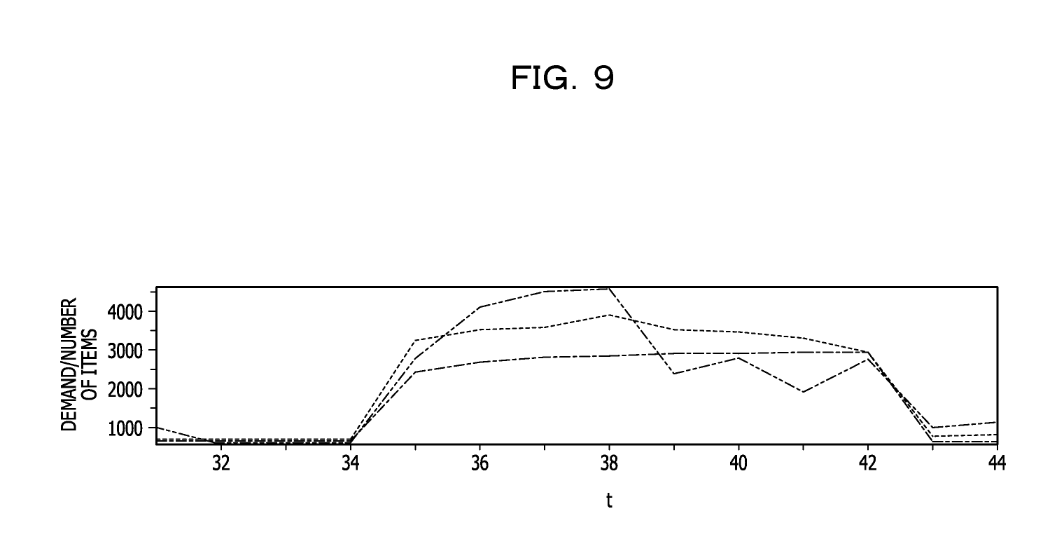

Next, using FIGS. 9 through 11, an example of an effect for forecast uncertainty is described. FIG. 9 is a chart illustrating a first example of the forecasted demand quantity. In FIG. 9, the ordinate represents the forecasted demand quantity in the unit of the number of items and the abscissa represents the period. A broken line represents the forecasted demand quantity in the forecasting method p₁. A chain dotted line represents the forecasted demand quantity in the forecasting method p₂. A chain double dotted line represents the forecasted demand quantity in the forecasting method p₃. As illustrated in the example of FIG. 9, a difference occurs in the demand quantity forecasted by each forecasting method in the periods 34 through 42.

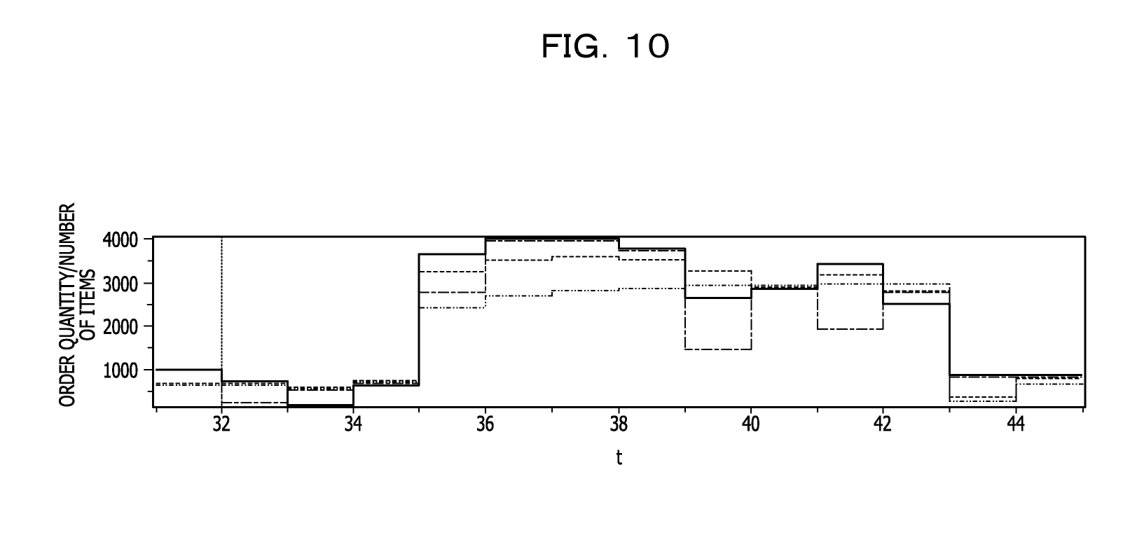

FIG. 10 is a chart illustrating a first example of the optimized order quantity. In FIG. 10, the ordinate represents the order quantity in the unit of the number of items and the abscissa represents the period. A broken line is the optimized order quantity calculated based on the forecasted demand quantity in the forecasting method p₁. A chain dotted line is the optimized order quantity calculated based on the forecasted demand quantity in the forecasting method p₂. A chain double dotted line is the optimized order quantity calculated based on the forecasted demand quantity in the forecasting method p₃.

In the meanwhile, a solid line is a transition of the optimized order quantity determined by the information processing device 100 for a highest minimum value of the profit. The optimized order quantity calculation unit 130 calculates the optimized order quantity u[k] through u[k+H] to maximize the minimum value of the forecast profit using each forecasted demand quantity corresponding to the forecasting methods p₁, p₂, and p₃.

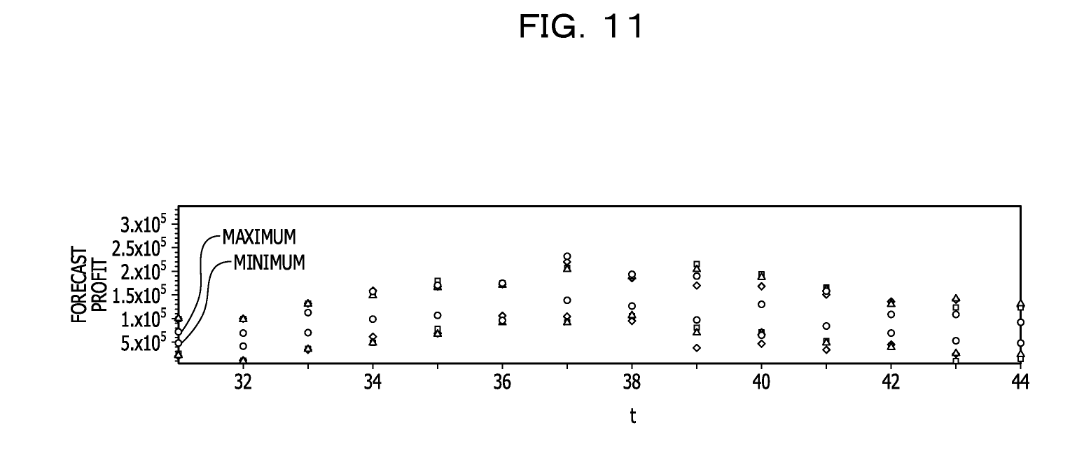

FIG. 11 is a chart illustrating a first example of the forecasted profit. In FIG. 11, the ordinate represents the forecast profit and the abscissa represents the period. As illustrated in the example of FIG. 11, a maximum value and a minimum value of the forecast profit in each period is calculated using the respective forecasted demand quantities forecasted by the forecasting methods p₁, p₂, and p₃. In FIG. 11, “A” are a maximum value and a minimum value of the forecast profit corresponding to the forecasting method p₁. “▪” are a maximum value and a minimum value of the forecast profit corresponding to the forecasting method p₂. “⋄” are a maximum value and a minimum value of the forecast profit corresponding to the forecasting method p₃. “◯” are a maximum value and a minimum value of the forecast profit calculated based on the optimized order quantities u[k] through u[k+H]. Among the two “◯” indicating the maximum value and the minimum value of the forecast profit of the optimized order quantities u[k] through u[k+H] in each period, the lower “◯” mostly exceeds the minimum values of the forecast profits in the forecasting methods p₁ through p₃. Therefore, in the optimized order quantities u[k] through u[k+H], the minimum value of the forecast profit becomes maximum by accumulating the minimum values of the forecast profit. The optimized order quantity calculation unit 130 obtains the profit forecast range by accumulating the maximum value and the minimum value of the forecast profit corresponding to “◯”.

In such a manner, the information processing device 100 determines the optimized order quantity using the plurality of demand forecasts, so that even when the demand varies irregularly and it is difficult to look ahead the demand forecast, it is possible to obtain an optimized order quantity that suppresses stock shortage and an increase in holding cost minimally.

(Effect for Looking Ahead)

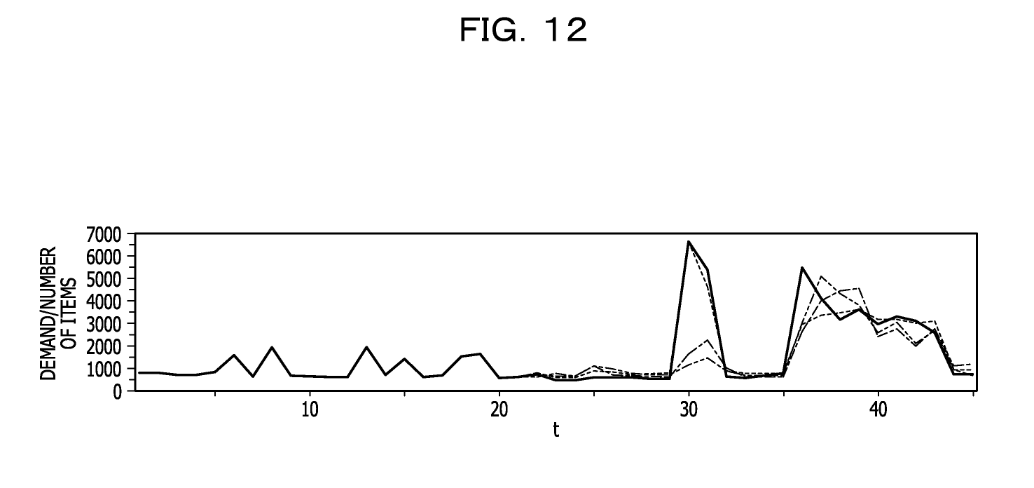

Next, using FIGS. 12 through 14, an example of an effect for looking ahead is described. FIG. 12 is a chart illustrating a second example of the forecasted demand quantity. In FIG. 12, the ordinate represents the forecasted demand quantity in the unit of the number of items and the abscissa represents the period. A broken line represents the forecasted demand quantity in the forecasting method p₁. A chain dotted line represents the forecasted demand quantity in the forecasting method p₂. A chain double dotted line represents the forecasted demand quantity in the forecasting method p₃. A solid line represents the actual demand quantity. As illustrated in the example of FIG. 12, the demand is forecasted in the periods 0 through 45, and the actual demand grows particularly in the periods between 29 and 32. In the example of FIG. 12, the forecasted demand quantities in the forecasting methods p₁ through p₃ match the actual demand quantity in the periods 0 through 21 so that the broken line, the chain dotted line, the chain double dotted line, and the solid line are overlapped. In addition, in the periods 22 through 32, the forecasted demand quantities in the forecasting methods p₁ through p₃ generally match the actual demand quantity. The demand quantity in the forecasting method p₁ generally matches the actual demand quantity in the periods 29 through 32 whereas the demand quantities in the forecasting methods p₂ and p₃ are less than the actual demand quantity.

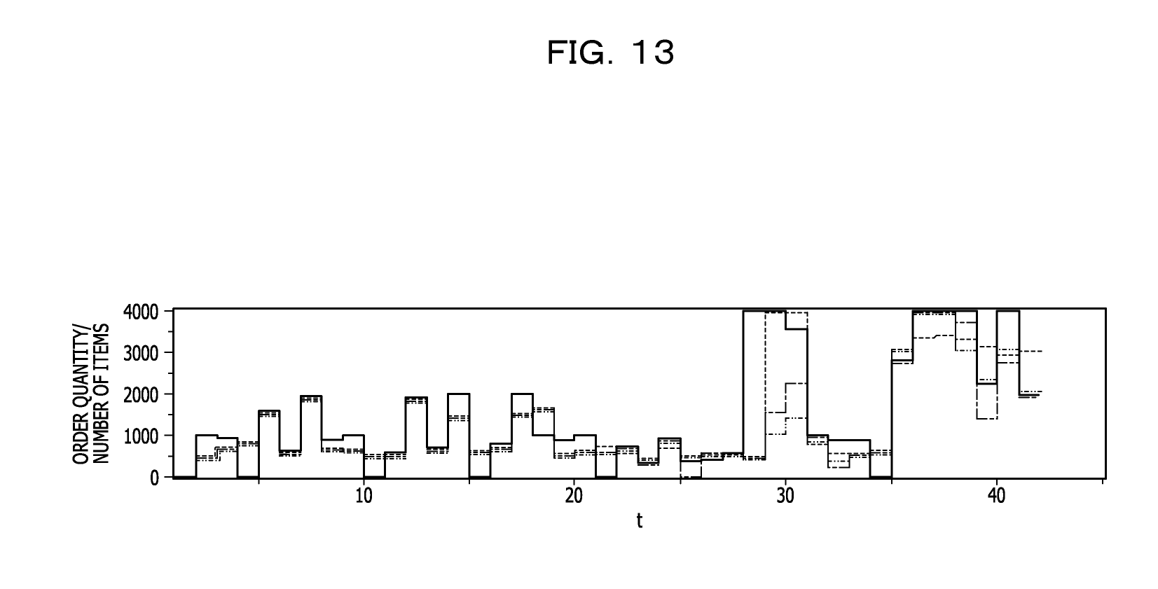

FIG. 13 is a chart illustrating a second example of the optimized order quantity. In FIG. 13, the ordinate represents the order quantity in the unit of the number of items and the abscissa represents the periods. A broken line is a forecasted order quantity by a related technique calculated based on the forecasted demand quantity in the forecasting method p₁. A chain dotted line is a forecasted order quantity by a related technique calculated based on the forecasted demand quantity in the forecasting method p₂. A chain double dotted line is a forecasted order quantity by a related technique calculated based on the forecasted demand quantity in the forecasting method p₃.

In the meanwhile, a solid line is a transition of the optimized order quantity determined by the information processing device 100 to maximize a minimum value of the profit. Even when the order quantity starts increasing in the period 29 when the demand starts growing, the information processing device 100 sometimes causes stock shortage because the order quantity limit for one period is 4000 and the product supply becomes too late. As illustrated with the solid line in the example of FIG. 13, the information processing device 100 increases the order quantity in the period 28 in preparation for the period 29 when the demand starts growing. It is thus possible to avoid stock shortage.

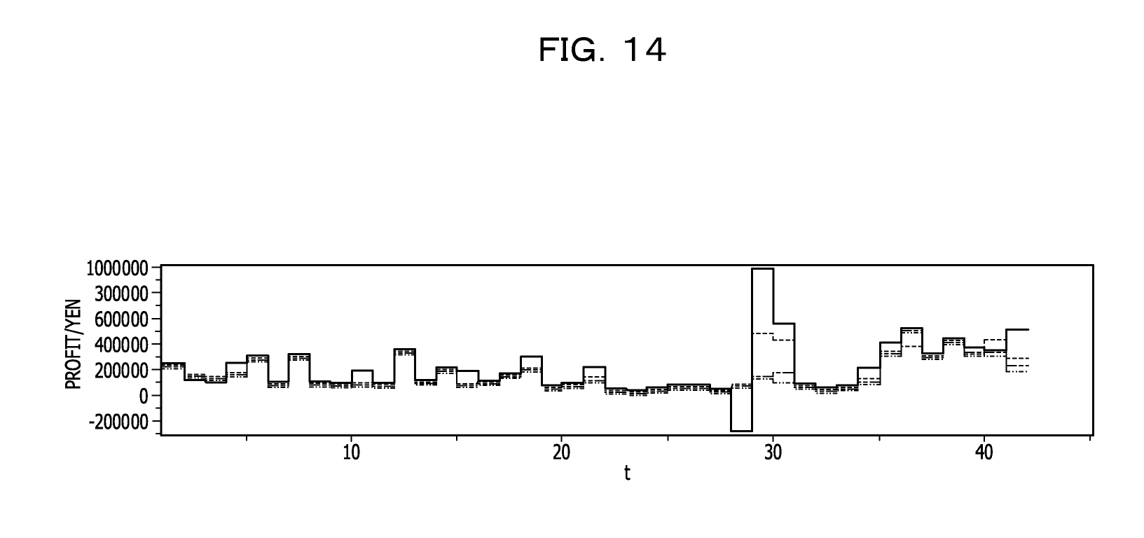

FIG. 14 is a chart illustrating a second example of the forecasted profit. In FIG. 14, the ordinate represents the profit and the abscissa represents the period. A broken line is the profit based on the forecasting method p₁. A chain dotted line is the profit based on the forecasting method p₂. A chain double dotted line is the profit based on the forecasting method p₃. A solid line is the profit based on the optimized order quantity. As illustrated in the example of FIG. 14, it is possible to avoid stock shortage, so that the profit based on the optimized order quantities in the periods 29 through 31 becomes greater.

In such a manner, the information processing device 100 brings forward the time to increase the order quantity in preparation for a rapid increase in the demand by increasing the looking-ahead section for the order quantity, so that it is possible to avoid stock shortage and secure the profit at a maximum.

The information processing device 100 is also capable of suppressing the order quantity from time earlier than the time when a decrease in the demand is estimated in preparation for a decrease in the demand by increasing the looking-ahead section for the order quantity.

(Effect of First Embodiment)

As have been described above, the information processing device 100 accepts the lead time from product order to arrival. The information processing device 100 calculates the stock quantity of the product based on the calculated arrival quantity of the product and the demand forecast value of the product. The information processing device 100 calculates the order quantity of the product based on the cost for holding the product in the calculated stock quantity, the price of the product, and the demand forecast value of the product. This enables the information processing device 100 to determine the order quantity considering the profit. That is, it is possible to determine an order quantity where a higher profit is estimated.

The information processing device 100 calculates the stock quantity of the product in the addition period in which the period of the lead time is added to a predetermined forecast period. The information processing device 100 calculates the order quantity by solving an optimization problem using the stock quantity of the product in the calculated addition period. The information processing device 100 may, thereby, forecast a change in the stock quantity added to the order placements in the forecast period, so that it is possible to improve the precision of the forecasted order in the forecast period.

The information processing device 100 forecasts the demand quantity of the product in the addition period. The information processing device 100 calculates the stock quantity of the product in the addition period by carrying out, to an actual stock quantity of the product, addition of the number of product items to arrive in the addition period and subtraction of a demand quantity of the product in the addition period when the lead time is an integer. This enables the information processing device 100 to order by precisely forecasting a change in the stock in the addition period.

The information processing device 100 forecasts the demand quantity of the product in the addition period. When the lead time is other than an integer, the information processing device 100 forecasts the demand quantity of the product in the period corresponding to a decimal part of the lead time to correct the actual stock quantity of the product with the demand quantity. The information processing device 100 calculates the stock quantity of the product in the addition period by carrying out, to a stock quantity after correction, addition of the number of product items to arrive in the addition period and subtraction of the demand quantity of the product in the addition period. This enables the information processing device 100 to order by precisely forecasting a change in the stock quantity at the time of delivery in the addition period even when the lead time includes a decimal part and the order time is different from the time of delivery.

The information processing device 100 accepts the constraint information to calculate the profit based on the order quantity of the product. The information processing device 100 searches for the order quantity from the k period to the k+H period for a greater profit using the constraint information. The information processing device 100 outputs the order quantity for the k period among the searched order quantities. This enables the information processing device 100 to determine the order quantity estimated to have a higher profit under a constraint.

The information processing device 100 obtains the order quantity for the k period by forecasting the demand from the k period to the k+H period and solving an optimization problem using the profit from the k period to the k+H period as the objective function considering the forecasted demand. In such a manner, the information processing device 100 is capable of precisely obtaining the optimized order quantity by solving an optimization problem using the objective function.

The information processing device 100 obtains the order quantity for the k period by solving an optimization problem using the profit from the k period to the k+H period as the objective function considering the actual demand. This enables the information processing device 100 to improve the precision of the forecasted demand quantity considering the actual demand and to precisely obtain the optimized order quantity based on the forecasted demand quantity.

The information processing device 100 outputs the profit forecast together with the order quantity. This enables the information processing device 100 to present the optimized order quantity and the forecasted profit range.

### Second Embodiment

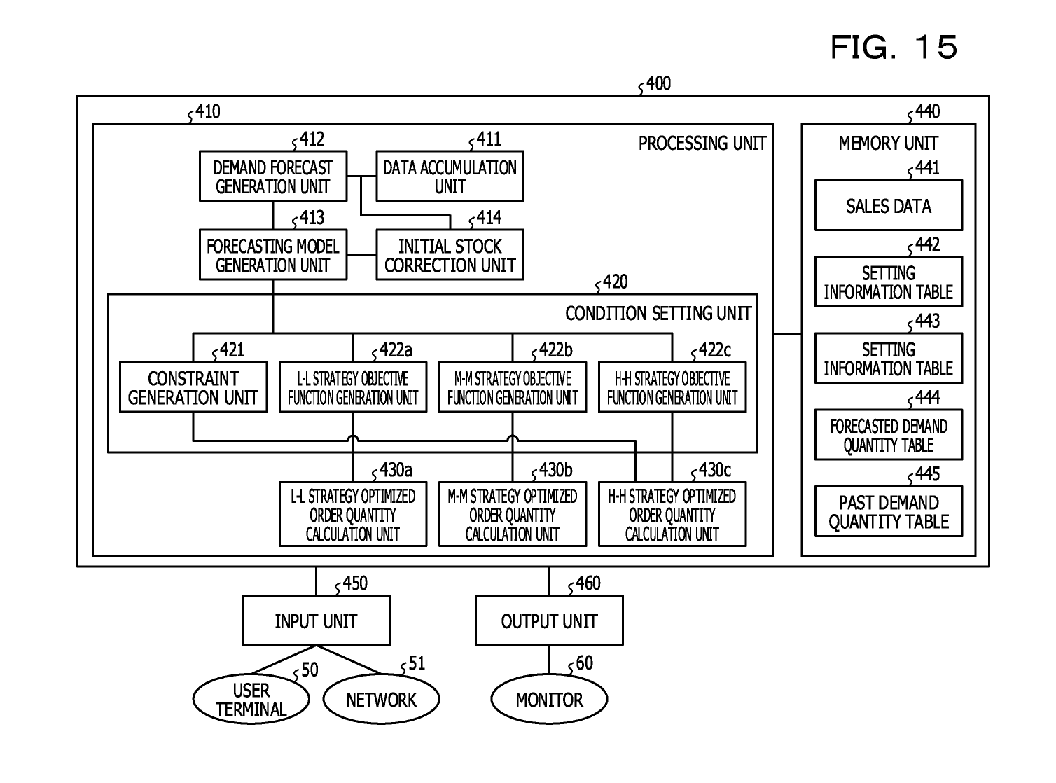

An example of the entire configuration of an information processing device 400 according to a second embodiment is described. FIG. 15 is a functional block diagram illustrating a configuration of an information processing device according to the second embodiment. As illustrated in the example of FIG. 15, the information processing device 400 has a processing unit 410 and a memory unit 440. The components same as the information processing device 100 in the first embodiment have the reference numerals in which the last two digits are identical to omit the description as appropriate.

(Description on Memory Unit)

The memory unit 440 has sales data 441, a setting information table 442, a forecasted demand quantity table 443, a past demand quantity table 444, and the past order quantity table 445. The memory unit 440 corresponds to, for example, a semiconductor memory device, such as a RAM, a ROM, and a flash memory, or a storage device, such as a hard disk and an optical disk.

(Description on Processing Unit)

The processing unit 410 has a data accumulation unit 411, a demand forecast generation unit 412, a forecasting model generation unit 413, an initial stock correction unit 414, and a condition setting unit 420. The processing unit 410 has an L-L strategy optimized order quantity calculation unit 430a, an M-M strategy optimized order quantity calculation unit 430b, and an H-H strategy optimized order quantity calculation unit 430c. The condition setting unit 420 has a constraint generation unit 421, an L-L strategy objective function generation unit 422a, an M-M strategy objective function generation unit 422b, and an H-H strategy objective function generation unit 422c. The information processing device 400 is connected to an input unit 450 and an output unit 460. The input unit 450 is connected to a user terminal 50 and a network 51. The output unit 460 is connected to a monitor 60.

It is possible to achieve each function of the processing unit 410 by, for example, causing a CPU to execute a predetermined program. It is also possible to achieve each function of the processing unit 410 by, for example, an integrated circuit, such as an ASIC and a FPGA.

The L-L strategy optimized order quantity calculation unit 430a forecasts a demand from the k period to the k+H period, using a plurality of approaches, for each approach. Further, the L-L strategy optimized order quantity calculation unit 430a obtains an order quantity for the k period for a higher profit by solving an optimization problem using the profit from the k period to the k+H period as the objective function to maximize a lowest value of the profit for each forecasted demand using a plurality of demand forecasts.

The M-M strategy optimized order quantity calculation unit 430b forecasts a demand from the k period to the k+H period, using a plurality of approaches, for each approach. Further, the M-M strategy optimized order quantity calculation unit 430b obtains an order quantity for the k period for a higher profit by solving an optimization problem using the profit from the k period to the k+H period as the objective function to maximize an average value for each forecasted demand using a plurality of approaches.

The H-H strategy optimized order quantity calculation unit 430c forecasts a demand from the k period to the k+H period, using a plurality of approaches, for each approach. Further, the H-H strategy optimized order quantity calculation unit 430c obtains an order quantity for the k period for a higher profit by solving an optimization problem using a profit from the k period to the k+H period as the objective function to maximize a maximum value of the profit for each forecasted demand using a plurality of demand forecasts. Detailed descriptions are given below to each configuration of the processing unit 410.

The condition setting unit 420 of the second embodiment has a low risk-low return (L-L) strategy objective function generation unit 422a, an middle risk-middle return (M-M) strategy objective function generation unit 422b, and a high risk-high return (H-H) strategy objective function generation unit 422c. The condition setting unit 420 is different from the condition setting unit 120 of the first embodiment in having the three objective function generation units. The processing unit 410 has the L-L strategy optimized order quantity calculation unit 430a, the M-M strategy optimized order quantity calculation unit 430b, and the H-H strategy optimized order quantity calculation unit 430c. The processing unit 410 is different from the processing unit 110 of the first embodiment in having three strategy optimized order quantity calculation units.

The information processing device 400 calculates an optimized order quantity and a forecasted profit range for each strategy, such as the L-L strategy, the M-M strategy, and the H-H strategy, to display the results on the monitor 60. Individual descriptions are given below to process of each strategy.

Process corresponding to the L-L strategy is described. The L-L strategy objective function generation unit 422a is a processing unit to generate an objective function to calculate an order quantity to maximize a minimum value of the profit in a specified period. For example, the L-L strategy objective function generation unit 422a generates a mathematical expression corresponding to the formula (11), (12), or (13) and a mathematical expression corresponding to the formula (14). In the formula (14), minPᵢ (i=1, . . . , N) is the lowest forecast profit among the forecast profits P₁ through P_{N}. The L-L strategy objective function generation unit 422a outputs each generated mathematical expression to the L-L strategy optimized order quantity calculation unit 430a.

The L-L strategy optimized order quantity calculation unit 430a is a processing unit to calculate the order quantity to maximize the minimum value of the profit in the specified period. The L-L strategy optimized order quantity calculation unit 430a obtains the optimized order quantities u[k] through u[k+H] by solving an optimization problem using the formulae (14) and (15). Subsequently, the L-L strategy optimized order quantity calculation unit 430a calculates forecast profits P₁ through P_{N} corresponding respectively to the forecasting methods p₁ through p_{N} using the optimized order quantities u[k] through u[k+H]. Subsequently, the L-L strategy optimized order quantity calculation unit 430a obtains the profit forecast range by selecting a maximum value and a minimum value among the calculated forecast profits P₁ through P_{N}. For example, the L-L strategy optimized order quantity calculation unit 430a calculates the minimum value of the profit forecast range by the formula (16). The L-L strategy optimized order quantity calculation unit 430a calculates the maximum value of the profit forecast range by the formula (17). Then, the L-L strategy optimized order quantity calculation unit 430a outputs the gross order quantity and the profit forecast range to the output unit 460. The gross order quantity is a total value of the optimized order quantity in each period.

$$\begin{matrix}{P}_{min}^{L} = {min}_{i = 1 … N} \{ {P}_{i}^{L} \} & ( 16 ) \\ {P}_{max}^{L} = {max}_{i = 1 … N} \{ {P}_{i}^{L} \} & ( 17 )\end{matrix}$$

Next, process corresponding to the M-M strategy is described. The M-M strategy objective function generation unit 422b is a processing unit to generate an objective function to calculate an order quantity to maximize an average value of the forecast profits P₁ through P_{N}. For example, the M-M strategy objective function generation unit 422b generates a mathematical expression corresponding to the formula (11), (12), or (13) and a mathematical expression corresponding to the formula (18) below. Eₚᵢ[Pᵢ] (i=1, . . . , N) of the formula (18) is an average value of the forecast profits P₁ through P_{N}. The M-M strategy objective function generation unit 422b outputs each generated mathematical expression to the M-M strategy optimized order quantity calculation unit 430b.

$${max}_{u [ k ] , … , u [ k + H ]} {E}_{pi} [ {P}_{i} ] ( i = 1 , … , N ) \qquad ( 18 )$$

The M-M strategy optimized order quantity calculation unit 430b is a processing unit to calculate an order quantity to maximize an average value of the forecast profits P₁ through P_{N}. The M-M strategy optimized order quantity calculation unit 430b obtains the optimized order quantities u[k] through u[k+H] by solving an optimization problem using the formulae (15) and (18). Subsequently, similar to the L-L strategy optimized order quantity calculation unit 430a, the M-M strategy optimized order quantity calculation unit 430b obtains the profit forecast range by calculating the forecast profits P₁ through P_{N} based on the optimized order quantities u[k] through u[k+H]. For example, the M-M strategy optimized order quantity calculation unit 430b calculates a minimum value of the profit forecast range by the formula (19). The M-M strategy optimized order quantity calculation unit 430b calculates a maximum value of the profit forecast range by the formula (20). Then, the M-M strategy optimized order quantity calculation unit 430b outputs the gross order quantity and the profit forecast range to the output unit 460.

$$\begin{matrix}{P}_{min}^{M} = {min}_{i = 1 … N} \{ {P}_{i}^{M} \} & ( 19 ) \\ {P}_{max}^{M} = {max}_{i = 1 … N} \{ {P}_{i}^{M} \} & ( 20 )\end{matrix}$$

Next, process corresponding to the H-H strategy is described. The H-H strategy objective function generation unit 422c is a processing unit to generate an objective function to calculate an order quantity to maximize a maximum value of the forecasted profit in a specified period. For example, the H-H strategy objective function generation unit 422c generates a mathematical expression corresponding to the formula (11), (12), or (13) and a mathematical expression corresponding to the formula (21) below. In the formula (21), maxPᵢ (i=1, . . . , N) is the maximum forecast profit among the forecast profits P₁ through P_{N}. The H-H strategy objective function generation unit 422c outputs each generated mathematical expression to the H-H strategy optimized order quantity calculation unit 430c.

$${max}_{u [ k ] , … , u [ k + H ]} {max}_{pi} {P}_{i} ( i = 1 , … , N ) \qquad ( 21 )$$

The H-H strategy optimized order quantity calculation unit 430c is a processing unit to calculate an order quantity to maximize a maximum value of the forecast profits P₁ through P_{N}. The H-H strategy optimized order quantity calculation unit 430c obtains optimized order quantities u[k] through u[k+H] by solving an optimization problem using the formulae (15) and (21). Subsequently, similar to the L-L strategy optimized order quantity calculation unit 430a, the H-H strategy optimized order quantity calculation unit 430c obtains a profit forecast range by calculating the forecast profits P₁ through P_{N} based on the optimized order quantities u[k] through u[k+H]. For example, the H-H strategy optimized order quantity calculation unit 430c calculates a minimum value of the profit forecast range by the formula (22). The H-H strategy optimized order quantity calculation unit 430c also calculates a maximum value of the profit forecast range by the formula (23). Then, the H-H strategy optimized order quantity calculation unit 430c outputs the gross order quantity and the profit forecast range to the output unit 460.

$$\begin{matrix}{P}_{min}^{H} = {min}_{i = 1 … N} \{ {P}_{i}^{H} \} & ( 22 ) \\ {P}_{max}^{H} = {max}_{i = 1 … N} \{ {P}_{i}^{H} \} & ( 23 )\end{matrix}$$

(Description on Output Unit)

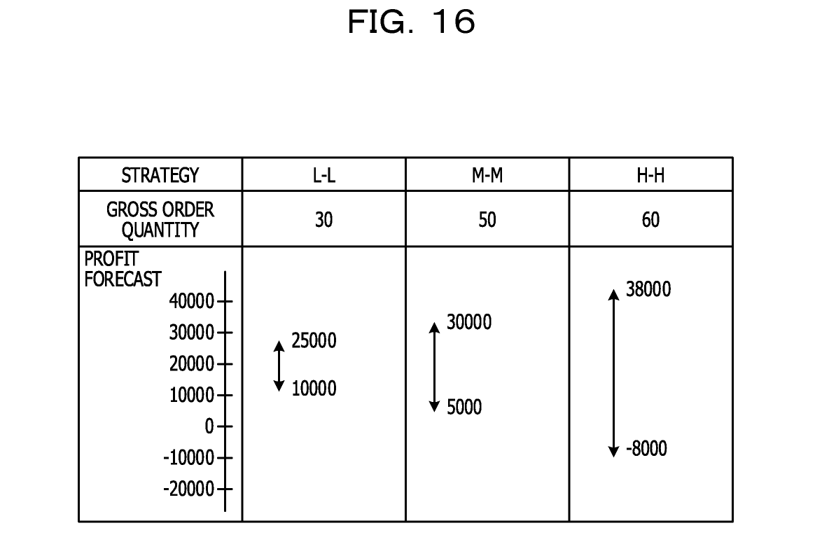

The output unit 460 is a processing unit to output a GUI image representing the gross order quantity and the profit forecast range corresponding to each strategy in a table format to an output device, such as a monitor. The output unit 460 generates a GUI image based on the gross order quantity and the profit forecast range of each strategy to output to the monitor 60. FIG. 16 is a chart illustrating a second example of the GUI image. As illustrated in the example of FIG. 16, the GUI image illustrates that, when employing the L-L strategy, the gross order quantity is 30, the maximum value of the profit forecast is 25000, and the minimum value is 10000. The GUI image also illustrates that, when employing the M-M strategy, the gross order quantity is 50, the maximum value of the profit forecast is 30000, and the minimum value is 5000. The GUI image also illustrates that, when employing the H-H strategy, the gross order quantity is 60, the maximum value of the profit forecast is 38000, and the minimum value is −8000. The output unit 460 is capable of displaying the profits and the risks when employing each strategy in a manner easy to compare by indicating the profit forecast range corresponding to each strategy with an arrow in parallel.

As described above, the information processing device 400 calculates the optimized order quantities and the profit range for each strategy, such as the L-L strategy, the M-M strategy, and the H-H strategy, so that it is possible to assist determination on an order quantity in accordance with the corporate strategy, such as focusing risk avoidance or focusing maximization of the profit.

(Effect of Second Embodiment)

As have been described above, the information processing device 400 forecasts the demand from the k period to the k+H period, using a plurality of approaches, for each approach. The information processing device 400 obtains an order quantity for the k period for a higher profit by solving an optimization problem using the profit from the k period to the k+H period as the objective function for a higher profit that may be minimally secured. It is thus possible to calculate an order quantity to maximize the minimum value of the profit.

The information processing device 400 forecasts the demand from the k period to the k+H period, using a plurality of approaches, for each approach to obtain a profit for each forecasted demand using the plurality of approaches. The information processing device 400 obtains the order quantity for the k period for a higher profit by solving an optimization problem using the profit from the k period to the k+H period as the objective function for a higher average value of the obtained profit. It is thus possible to calculate an order quantity for a higher profit when taking medium risks.

The information processing device 400 obtains an order quantity for the k period for a higher profit by forecasting the demand from the k period to the k+H period, using a plurality of approaches, for each approach and solving an optimization problem using the profit from the k period to the k+H period as the objective function for a higher maximum value of the forecasted profit. It is thus possible to calculate an order quantity to maximize a maximum value of the profit.

### Other Embodiments Related to First and Second Embodiments

Although the demand forecast generation unit 112 calculates the forecasted demand quantities Dₚᵢ[k] through Dₚᵢ[k+H] from the k period to the k+H period using the demand quantities Dᵣ[1] through Dᵣ[k−1] in the past in the first embodiment, this is not limiting. The demand forecast generation unit 112 may also reflect the actual demand quantity Dᵣ in the k period or later on the forecasted demand quantities Dₚᵢ when acquiring the actual demand quantity Dᵣ in the k period or later. For example, the demand forecast generation unit 112 or the demand forecast generation unit 412 may also be calculate the forecasted demand quantities Dₚᵢ[k+1] through Dₚᵢ[k+H] from the k+1 period to the k+H period when acquiring the actual demand quantity Dᵣ[k] in the k period.

Although the case of causing the past order quantity table 145 to retain data related to the already ordered order quantity of the product is described in the first embodiment, this is not limiting. For example, the past order quantity table 145 may also accept and memorize the order quantity of the product that is actually placed an order. For example, in the information processing device 100, the order quantity of the product that is actually placed an order from the order entry system 200 may also be received by the input unit 150 to be memorized in the past order quantity table 145 by the processing unit 110.

The case of accepting an input of setting information, such as the selling price of the product, the lead time, the order cost, the holding cost, the disposal cost, the order quantity limit, the stock quantity limit, the looking-ahead section, and the disposal time, as the constraint information is described in the first embodiment, this is not limiting. For example, when the selling price of the product, the order cost, the holding cost, the disposal cost, the order quantity limit, the stock quantity limit, the looking-ahead section, the disposal time, and the like are set in advance, the set information may also be used.

Although the information processing device 400 calculates the optimized order quantities and the profit forecast range respectively for the L-L strategy, the M-M strategy, and the H-H strategy in the second embodiment, this is not limiting. For example, the information processing device 400 may also calculate the optimized order quantity and the profit range, among the calculated forecast profits P₁ through P_{N}, to have a profit in the i-th (i=1, . . . , N) order of the profit higher.

The information processing device 100 of the first embodiment or the information processing device 400 of the second embodiment may also increase the optimized order quantities u[k+1] through u[k+H] in the k+1 period or later when the actual demand quantity in the k period is more than the forecasted demand quantity and stock shortage occurs.

Although the constraint generation unit 121 generates the constraint condition of the formula (10) where the stock quantity is kept 0 or greater in all cases in the first embodiment, this is not limiting. For example, the constraint generation unit 121 may also set a margin α in a predetermined quantity for the stock quantity to generate the constraint condition where the stock quantity is kept α or greater.

In the first embodiment, the looking-ahead section inputted from the user terminal 10 may be modified in the length in accordance with the nature of product. For example, the looking-ahead section may be set shorter for fresh foods.

Although the optimized order quantity calculation unit 130 calculates the optimized order quantity by solving an optimization problem using a plurality of demand forecasts in the first embodiment, this is not limiting. For example, the optimized order quantity calculation unit 130 may also solve an optimization problem using one demand forecast.

In the first embodiment, the selling price of the setting ID “2” in the setting information table 142 may also change by time. The setting information table 142 may also store, for example, an initial selling price in the setting 1, a selling price after the change in the setting 2, and time to change in the condition value.

Unless otherwise specified, the process procedures, the control procedures, the specific names, the information including various types of data and parameters mentioned in the first and second embodiments may be modified arbitrarily.

Each component of the information processing device 100 illustrated in FIG. 1 and the information processing device 400 in FIG. 15 is functionally conceptual and does not have to be configured as illustration physically. That is, the specific mode of distribution and integration of the information processing device 100 is not limited to the illustration and all or part may be configured functionally or physically in distribution and integration in an arbitrary unit in accordance with various loads, state of use, and the like.

(Hardware Configuration of Information Processing Device)

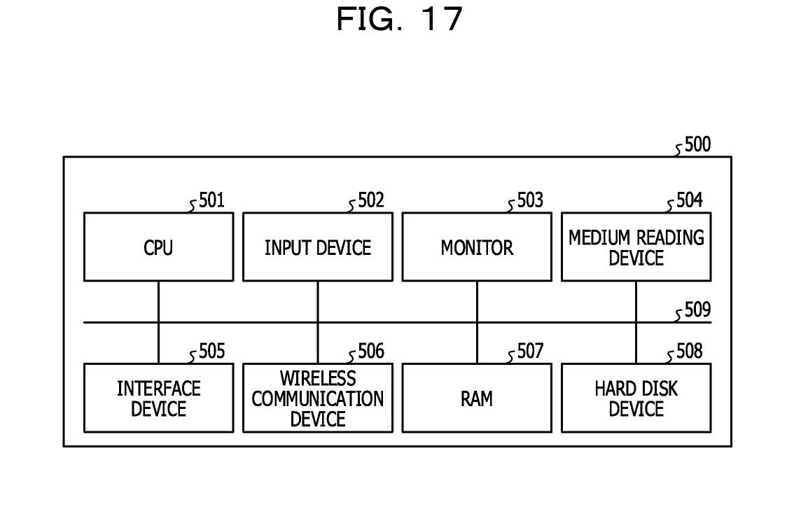

FIG. 17 is a diagram illustrating a hardware configuration of the information processing device of the first embodiment or the second embodiment. As illustrated in FIG. 17, a computer 500 has a CPU 501 executing various types of operational process, an input device 502 accepting a data input from a user, and a monitor 503. The computer 500 also has a medium reading device 504 reading a program and the like from a memory medium, an interface device 505 for connection with another device, and a wireless communication device 506 for connection with another device wirelessly. The computer 500 also has a random access memory (RAM) 507 temporarily memorizing various types of information and a hard disk device 508. The respective devices 501 through 508 are connected to a bus 509.

The hard disk device 508 memorizes an order quantity determination program having functions similar to the data accumulation unit 111, the demand forecast generation unit 112, the forecasting model generation unit 113, the constraint generation unit 121, the objective function generation unit 122, and the optimized order quantity calculation unit 130 of the processing unit 110 illustrated in FIG. 1. In the hard disk device 508, various types of data to achieve the order quantity determination program are memorized.

The CPU 501 carries out various types of process by reading each program memorized in the hard disk device 508 and executing by developing on the RAM 507. These programs may cause the computer 500 to function as the data accumulation unit 111, the demand forecast generation unit 112, the forecasting model generation unit 113, the constraint generation unit 121, the objective function generation unit 122, and the optimized order quantity calculation unit 130 of the processing unit 110 illustrated in FIG. 1.

The order quantity determination program does not have to be memorized in the hard disk device 508. For example, the computer 500 may also read and execute a program memorized in a memory medium capable of being read by the computer 500. The memory medium capable of being read by the computer 500 may include, for example, a portable recording medium such as a CD-ROM, a DVD disk, and a universal serial bus (USB) memory, a semiconductor memory such as a flash memory, a hard disk drive, and the like. The program may also be memorized in a device connected to a public network, the Internet, a local area network (LAN), and the like to be read and executed from there by the computer 500.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An order quantity determination method comprising:
accepting lead time from product order to arrival;
calculating a stock quantity of the product by a processor based on an arrival quantity of the product and a demand forecast value of the product, the arrival quantity of the product is calculated based on the accepted lead time and order time of the product; and
calculating an order quantity of the product by a processor based on a cost for holding the calculated stock quantity of the product, a price of the product, and the demand forecast value of the product.

2. The order quantity determination method according to claim 1, wherein
the calculating the stock quantity of the product calculates the stock quantity of the product in an addition period in which a period of the lead time is added to a predetermined forecast period, and
the calculating the order quantity of the product calculates the order quantity by solving an optimization problem using the stock quantity of the product in the calculated addition period.

3. The order quantity determination method according to claim 2, wherein the calculating the stock quantity of the product includes:
forecasting a demand quantity of the product in the addition period, and
in a case that the lead time is an integer, calculating the stock quantity of the product in the addition period by carrying out, to an actual stock quantity of the product, addition of a number of product items to arrive in the addition period and subtraction of a demand quantity of the product in the addition period.

4. The order quantity determination method according to claim 2, wherein the calculating the stock quantity of the product includes:
forecasting a demand quantity of the product in the addition period,
when the lead time is other than an integer, forecasting a demand quantity of the product in a period corresponding to a decimal part of the lead time to correct an actual stock quantity of the product with the demand quantity, and
calculating the stock quantity of the product in the addition period by carrying out, to a stock quantity after correction, addition of a number of product items to arrive in the addition period and subtraction of a demand quantity of the product in the addition period.

5. A non-transitory computer-readable medium storing therein an order quantity determination program that causes a computer to execute a process, the process comprising:
accepting lead time from product order to arrival;
calculating a stock quantity of the product by a processor based on an arrival quantity of the product and a demand forecast value of the product, the arrival quantity of the product is calculated based on the accepted lead time and order time of the product; and
calculating an order quantity of the product by a processor based on a cost for holding the calculated stock quantity of the product, a price of the product, and the demand forecast value of the product.

6. The non-transitory computer-readable medium according to claim 5, wherein
the calculating the stock quantity of the product calculates the stock quantity of the product in an addition period in which a period of the lead time is added to a predetermined forecast period, and
the calculating the order quantity of the product calculates the order quantity by solving an optimization problem using the stock quantity of the product in the calculated addition period.

7. The non-transitory computer-readable medium according to claim 6, wherein the calculating the stock quantity of the product includes:
forecasting a demand quantity of the product in the addition period, and
in a case that the lead time is an integer, calculating the stock quantity of the product in the addition period by carrying out, to an actual stock quantity of the product, addition of a number of product items to arrive in the addition period and subtraction of a demand quantity of the product in the addition period.

8. The non-transitory computer-readable medium according to claim 6, wherein the calculating the stock quantity of the product includes:
forecasting a demand quantity of the product in the addition period,
when the lead time is other than an integer, forecasting a demand quantity of the product in a period corresponding to a decimal part of the lead time to correct an actual stock quantity of the product with the demand quantity, and
calculating the stock quantity of the product in the addition period by carrying out, to a stock quantity after correction, addition of a number of product items to arrive in the addition period and subtraction of a demand quantity of the product in the addition period.

9. An information processing device comprising:
a memory; and
a processor coupled to the memory and configured to execute a process, the process comprising:
accepting lead time from product order to arrival,
calculating a stock quantity of the product by a processor based on an arrival quantity of the product and a demand forecast value of the product, the arrival quantity of the product is calculated based on the accepted lead time and order time of the product, and
calculating an order quantity of the product by a processor based on a cost for holding the calculated stock quantity of the product, a price of the product, and the demand forecast value of the product.

10. The information processing device according to claim 9, wherein
the calculating the stock quantity of the product calculates the stock quantity of the product in an addition period in which a period of the lead time is added to a predetermined forecast period, and
the calculating the order quantity of the product calculates the order quantity by solving an optimization problem using the stock quantity of the product in the calculated addition period.

11. The information processing device according to claim 10, wherein the calculating the stock quantity of the product includes:
forecasting a demand quantity of the product in the addition period, and
in a case that the lead time is an integer, calculating the stock quantity of the product in the addition period by carrying out, to an actual stock quantity of the product, addition of a number of product items to arrive in the addition period and subtraction of a demand quantity of the product in the addition period.

12. The information processing device according to claim 10, wherein the calculating the stock quantity of the product includes:
forecasting a demand quantity of the product in the addition period,
when the lead time is other than an integer, forecasting a demand quantity of the product in a period corresponding to a decimal part of the lead time to correct an actual stock quantity of the product with the demand quantity, and
calculating the stock quantity of the product in the addition period by carrying out, to a stock quantity after correction, addition of a number of product items to arrive in the addition period and subtraction of a demand quantity of the product in the addition period.
